(19) United States
(12) Patent Application Publication
(10) Pub. No.: US 2006/0125131 A1
(43) Pub. Date: Jun. 15, 2006

(54) CARBONACEOUS POROUS MATERIAL AND METHOD OF MANUFACTURING SAME

(75) Inventors: Yoshihisa Suda, Fujioka (JP); Atsunori Satake, Fujioka (JP)

Correspondence Address: FOLEY AND LARDNER LLP;SUITE 500, 3000 K STREET NW, WASHINGTON, DC, 20007, US

(73) Assignee: MITSUBISHI PENCIL CO., LTD.

(21) Appl. No.: 11/275,948

(22) Filed: Feb. 6, 2006

Related U.S. Application Data
(62) Division of application No. 10/265,711, filed on Oct. 8, 2002.

(30) Foreign Application Priority Data
Oct. 18, 2001 (JP) 2001-320895

(51) Int. Cl. C01B 31/02

(52) U.S. Cl. 264/29.1

(57) ABSTRACT

A carbonaceous porous material having excellent mechanical strength is obtained by mixing a resin, that can be used as starting material for amorphous carbon, uniformly with carbon powder and an organic substance with a carbon residue rate of 0˜5% and, after molding the mixture in an arbitrary shape, carbonizing the mixture at temperature of 500° C. or higher.

This application is a Divisional Application of Application Ser. No. 10/265,711, filed Oct. 8, 2002.

### BACKGROUND OF THE INVENTION

1. Field of the Invention

The present invention relates to a carbonaceous porous material and a method of manufacturing the same.

2. Description of Related Art

In general, carbon is excellent in heat resistance, anti-corrosion characteristics, and chemical resistance, and is widely used for applications such as a heater material, an electrode material, or jigs which require high heat resistance or chemical resistance, etc. In particular, a porous carbon material is used as electrode material for a fuel cell, a heat insulating material, or various filter materials. However, due to its porosity, carbonaceous porous material is significantly lower in mechanical strength compared to ordinary carbon material. There are also problems such as production of dust due to carbon particles from surfaces.

### SUMMARY OF THE INVENTION

It is an object of the present invention to provide a carbonaceous porous material which is excellent in mechanical strength and which produces very little carbon dust associated with carbon particles from surfaces, and a method of making the same.

The present invention utilizes amorphous carbon as the structural material and provides a carbonaceous porous material which exhibits the same excellent property in gas impermeability, chemical resistance, and mechanical strength as amorphous carbon, and which can also effectively suppress the production of dust due to carbon particles from surfaces.

The carbonaceous porous material of the present invention includes amorphous carbon as the structural material, and further contains carbon powder in an amount of 0˜50%, wherein the bulk density is in the range of 0.3˜1.3 g/cm³. This carbonaceous porous material is manufactured by mixing 100 parts of the starting material of amorphous carbon uniformly with 0˜100 parts of carbon powder and 10˜200 parts of an organic substance with carbon residue rate of 0˜5% and, after molding the mixture in an arbitrary shape, by carbonizing the molding at temperature of 500° C. or higher. As the starting material of amorphous carbon, a polymer material which is capable of producing a composite product integrated with the mixed carbon powder by carbonizing it in an inert atmosphere, a non-oxidative atmosphere, or in a vacuum, and preferably exhibits carbonization yield of 5% or higher by carbonizing, is used. More specifically, useful polymer materials include, for example, a thermoplastic resin such as polyvinyl chloride, polyacrylonitrile, polyvinyl alcohol, polyvinyl chloride-polyvinyl acetate-copolymer, polyamide, etc., a thermosetting resin such as phenol resin, furan resin, imide resin, epoxy resin, unsaturated polyester resin, etc., natural polymer materials having condensed polycyclic aromatic group in basic structure such as lignin, cellulose, tragacanth gum, gum arabic, saccharides, etc., a formalin condensation product of naphthalene sulfonate which is not included in the above group, and synthetic polymers having condensed polycyclic aromatic group in basic structure such as KOPUNA resin, etc. The type and amount of polymer materials to be used are suitably selected depending upon the characteristics, strength and shape of the intended carbonaceous porous material, and may be used alone or in mixture of two or more of them.

In the present invention, in addition to the amorphous carbon as structural material, carbon powder is mixed as required. This is effective for improving moldability, and also for adjusting the value of the resistance and the thermal expansion coefficient.

There is no special restriction as regards the organic substance with carbon residue rate of 0˜5%, as long as it is gasified during the carbonizing process and it functions satisfactorily as pore forming agent so as to provide cavities in the carbon molding. Suitable examples of the organic substance include acrylic resin, styrene resin, epoxy resin, nylon, polyvinyl chloride, polyurethane, polyacetal, etc. These substances may be used in any appropriate form, for example, they may be mixed in granules with other component in the molding and carbonized after being molded. Or, they may be dissolved in a suitable solvent and then mixed. These organic substances may be used alone or in a mixture of two or more of them.

### EXAMPLES

### Example 1

40 parts of polyvinyl chloride-polyvinyl acetate copolymer (manufactured by Shin-Daiiti-Enbi Co., ZEST-C150S) and 10 parts of furan resin (manufactured by Hitachi Chemical Co., Hitafuran VF-303) as the starting materials for amorphous carbon were mixed to obtain mixed resin, to which 50 parts of polymethyl mathacrylate (manufactured by Sekisui Chemical Co., Techpolymer BM-50) and 10 parts of natural flake graphite (manufactured by Nippon Graphite Industries Co.) were added. After adding diallyl phthalate monomer in an amount of 20%, the mixture was dispersed using a Henschel mixer, and kneaded fully using a mixing roller to produce a composition. The obtained composition was pelletized using a pelletizer and a molding composition in the shape of pellets was obtained.

The composition in the form of pellets was extrusion-molded to form a linear molding while removing gas using a screw extruder. This molding was processed in an air oven heated at 180° C. for 10 hours, and a carbon precursor was obtained. This carbon precursor was carbonized in a nitrogen gas atmosphere at 1500° C. for 3 hours, and a carbonaceous porous body was obtained.

The obtained carbonaceous porous body exhibited following physical characteristics: ρ=0.6 g/cm³, and bending strength of 11 MPa.

### Example 2

Composition consisting of 90 parts of furan resin (manufactured by Hitachi Chemical Co., Hitafuran VF-303) as the starting material for amorphous carbon, 10 parts of natural flake graphite (manufactured by Nippon Graphite Industries Co.) and 50 parts of polymethyl methacrylate (manufactured by Nippon Graphite Industries Co., Techpolymer BM-50) was fully mixed and stirred using a Pony mixer, and then 1.5 parts of p-toluene sulfonic acid was added and fully mixed and stirred. Then, obtained composition was poured into a metal pattern and, after the molding was heated and solidified at 90° C., it was sandwiched between heat resistant ceramic plates and heat treatment was performed at 1000° C. for 3 hours in a vacuum carbonizing furnace to obtain a carbonaceous porous body.

The obtained carbonaceous porous body exhibited following physical characteristics: p=1.0 g/cm³ and a bending strength of 30 MPa.

The carbonaceous porous material of the present invention has amorphous carbon as the structural member so that it has the same characteristics as the amorphous carbon, and is therefore excellent in mechanical characteristics such as bending strength and bending elasticity. In addition, it hardly produces carbon dust which has been a problem with existing carbon materials and porous carbon materials. The carbonaceous porous material of the present invention is obtained using conventional plastic molding process so that it can be formed in an arbitrary shape and requires no further processing after carbonizing process. Therefore, compared to conventional carbon material, the carbonaceous porous material of the present invention can be provided as a product in a simpler process and at lower cost.

1. A method of manufacturing a carbonaceous porous material, comprising the steps of:
mixing uniformly 100 parts of starting material for amorphous carbon with 0˜100 parts of carbon powder and 10˜200 parts of organic substance of carbon residue rate of 0˜5%;
molding the mixture in an arbitrary shape; and
carbonizing the molding at temperature of 500° C. or higher.
